(19) United States
(12) Patent Application Publication
(10) Pub. No.: US 2012/0065753 A1
(43) Pub. Date: Mar. 15, 2012

(54) AUDIO SIGNAL ENCODING AND DECODING METHOD, AND APPARATUS FOR SAME

(75) Inventors: Ki Hyun Choo, Yongin-si (KR); Jung-Hoe Kim, Yongin-si (KR); Eun Mi Oh, Yongin-si (KR)

(73) Assignee: SAMSUNG ELECTRONICS CO., LTD., Suwon-si (KR)

(21) Appl. No.: 13/254,120

(22) PCT Filed: Feb. 2, 2010
(86) PCT No.: PCT/KR2010/000631

§ 371 Date: Aug. 31, 2011

(30) Foreign Application Priority Data
Feb. 3, 2009 (KR) 10-2009-0008616
Feb. 2, 2010 (KR) 10-2010-0009369

(51) Int. Cl. G06F 17/00

(52) U.S. Cl. 700/94

(57) ABSTRACT

A method for performing coding and decoding with respect to an audio signal or a speech signal, and an apparatus applying the method are provided.

### TECHNICAL FIELD

Example embodiments relate to a method of coding and decoding an audio signal or a speech signal and an apparatus for accomplishing the method.

### BACKGROUND ART

A method for coding and decoding an audio signal or a speech signal, and more particularly, a moving picture expert group (MPEG) audio coding and decoding method will be described. In particular, a method and apparatus for coding and decoding MPEG-D unified speech and audio coding (USAC) being standardized by the MPEG capable of insertion of additional information.

A waveform containing information is an analog signal which is continuous in amplitude and time. Therefore, when the waveform is expressed as a discrete signal, analog-to-digital (A/D) conversion needs to be performed. Two processes are required for the A/D conversion; one is sampling for converting the temporally continuous signal to the discrete signal, and the other is amplitude quantization for limiting a number of available amplitudes to a finite value.

With the recent development of a digital signal processing technology, a conventional analog signal is converted to pulse code modulation (PCM) data, that is, a digital signal, through the sampling and the quantization, and the digital signal is stored in a recording and storing medium such as a compact disc (CD) or a digital audio tape (DAT) to be reproduced as required by a user. Such a method of storing and recovering the digital signal achieves improvement in sound quality and overcomes deterioration caused by an increased storage period, in comparison with an analog system such as a long-play (LP) record or a tape. However, data size is relatively large.

To reduce the data size, efforts have been made using differential pulse code modulation (DPCM), adaptive DPCM (ADPCM), or the like developed to compress a digital audio signal. However, efficiency of those methods is unstable according to a signal type. Recently, an MPEG/audio method standardized by the international standard organization (ISO) or an AC-2/AC-3 method developed by Dolby suggested a data reduction method using a psychoacoustic model. The data reduction method is effective in reducing the data size regardless of characteristics of the signal.

According to conventional audio signal coding methods such as MPEG-1/audio, MPEG-2/audio, AC-2/AC-3, and the like, signals in a time domain are classified by a block having a predetermined size and thereby converted to signals of a frequency domain. Scalar-quantization of the converted signals is performed using a psychoacoustic model of a human. The quantization method is simple but is not optimized although an input sample is statistically independent. Conversely, the quantization method would be less optimized when the input sample is statistically dependent. Accordingly, coding is performed together with lossless coding, such as entropy coding, or a certain type of adaptive quantization. In this case, however, the signal processing becomes much more complicated in comparison to when only simple PCM data is stored. A coded bit stream includes not only quantized PCM data but also additional information for signal coding.

The MPEG/audio standard and the AC-2/AC-3 methods are capable of providing sound quality almost equivalent to that of the CD, with a bit rate of about 64 Kbps to 384 Kbps, that is, about ⅙ to ⅛ of a bit rate of the conventional digital coding method. The MPEG/audio standard is expected to perform an important role in storing and transmitting audio signals in a digital audio broadcasting (DAB) system, an internet phone service, an audio on demand (AOD) system, and multimedia systems.

### DISCLOSURE OF INVENTION

### Technical Solutions

Example embodiments provide a moving picture expert group (MPEG)-D unified speech and audio coding (USAC) coding and decoding method and apparatus for inserting additional information.

Example embodiments also provide a method for determining whether additional information of audio data coded by the MPEG-D USAC is inserted.

### Effects

According to example embodiments, additional information is inserted in a moving picture expert group (MPEG)-D unified speech and audio coding (USAC) method, thereby improving metadata related to audio content and sound quality and accomplishing a differentiated service.

According to example embodiments, extensibility of the MPEG-D USAC is provided.

### BRIEF DESCRIPTION OF DRAWINGS

FIG. 1 illustrates a diagram showing an example of a structure of a bit stream of ID3v1;

FIG. 2 illustrates a block diagram of an apparatus for coding an audio signal or a speech signal, according to example embodiments;

FIG. 3 illustrates a flowchart showing an example of a coding method performed by an apparatus for coding an audio signal or a speech signal according to example embodiments;

FIG. 4 illustrates a block diagram of an apparatus for decoding an audio signal or a speech signal, according to example embodiments; and

FIG. 5 illustrates a flowchart showing an example decoding method performed by an apparatus for decoding an audio signal or a speech signal according to example embodiments.

### BEST MODE FOR CARRYING OUT THE INVENTION

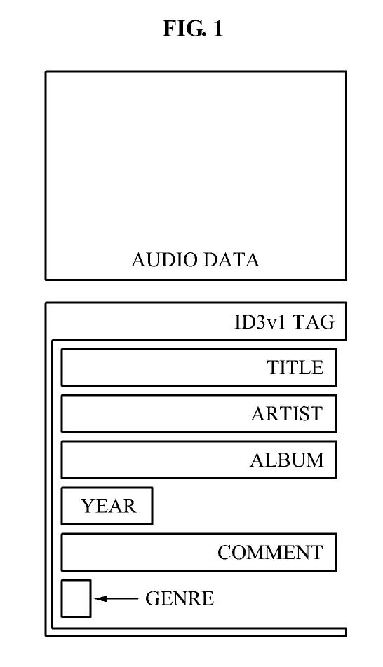

Moving picture expert group (MPEG)-2/4 advanced audio coding (AAC) (international standard organization/international electrotechnical commission (ISO/IEC) 13818-7, ISO/IEC 14496-3) defines a syntax for storing additional information, such as data_stream_element( ) or fill_element( ). In a case of an MPEG-1 layer-III(mp3), ancillary data is defined and additional information related to audio signals may be stored in a middle of frame information. ID3vl is a representative example of the additional information. FIG. 1 illustrates an example of a structure of a bit stream of ID3vl.

With the advent of multimedia age, various coding apparatuses supporting a variable bit rate are necessary. When a bandwidth of a network channel is fixed, even the coding apparatus supporting a variable bit rate uses a fixed bit rate. In this case, when a number of used bits is varied per frame, transmission by the fixed bit rate is unavailable. Therefore, additional bit information is transmitted. When a plurality of frames is transmitted in a bundle by a single payload, the plurality of frames may be generated by a variable bit rate. However, in this case as well, when the bandwidth of the network channel is fixed, transmission needs to be performed by the fixed bit rate. Here, a function of transmitting one payload by the fixed bit rate is required. For this, additional bit information is transmitted.

The MPEG-D USAC under standardization does not define syntax for providing additional information. Referring to [Syntax 1] below, an upper level payload of USAC syntax is defined.

[Syntax 1]

| | | |
|---|---|---|
| Syntax | No. of bits | Mnemonic |

usac_raw_data_block( )
{

```
if ( channelConfiguration == 0 ) {
    /* reserved */
}
if ( channelConfiguration == 1 ) {
    single_channel_element( );
}
if ( channelConfiguration == 2 ) {
    channel_pair_element( );
}
if ( channelConfiguration == 3 ) {
    single_channel_element( );
    channel_pair_element( );
}
if ( channelConfiguration == 4 ) {
    single_channel_element( );
    channel_pair_element( );
    single_channel_element( );
}
if ( channelConfiguration == 5 ) {
    single_channel_element( );
    channel_pair_element( );
    channel_pair_element( );
}
if ( channelConfiguration == 6 ) {
    single_channel_element( );
    channel_pair_element( );
    channel_pair_element( );
    lfe_channel_element( );
}
if ( channelConfiguration == 7 ) {
    single_channel_element( );
    channel_pair_element( );
    channel_pair_element( );
    channel_pair_element( );
    lfe_channel_element( );
}
if ( channelConfiguration >= 8 ) {
    /* reserved */
}
if ( sbrPresentFlag > 0 ) {
    sbr_extension_data( );
}
if ( mpegsMuxMode > 0 ) {
    SpatialFrame( );
}
byte_alignment( );
```

}
usac_raw_data_block( ) block of raw data that contains audio data for a time period of one AAC frame, related information and other data. Depending on the channel_configuration, a combination of one or more audio_channel_elements is followed if applicable by the sbr_extension_data( ), and if enabled, the SpatialFrame( )payload.
single_channel_element( ) abbreviaton SCE. Syntactic element of the bitstream containing coded data for a single audio channel. A single_channel_element( )basically consists of either of a fd_channel_stream( ) or a lpd_channel_stream( ) depending on the selectedcore_mode.
channel_pair_element( ) abbreviation CPE. Syntactic element of the bitstream payload containing data for a pair of channels. Core modes are signalled for each channel separately. Depending on these core modes the CPE contains a combination of lpd_channel_stream( ) and fd_channel_stream( )elements respectively. The two channels may share common side information.
lfe_channel_element( ) Abbreviation LFE. Syntactic element that contains a low sampling frequency enhancement channel. LFEs are always encoded using the fd_channel_stream( ) element.
sbr_extension_data( ) Syntactic element that contains the SBR extension data. Compared to the corresponding element described in ISO/IEC 14496-3, subclause4 4.4.2.8, the byte alignment bits bs_fill_bits have been removed from SBR extension data.
SpatialFrame( ) Syntax for performing decoding of mpegs tool.

Contents defined above are the same as the syntax currently discussed in relation to MPEG-D USAC.

As defined above, since the upper level payload syntax of the USAC does not define syntax for insertion of additional information, insertion of the additional information is unavailable according to a current standard.

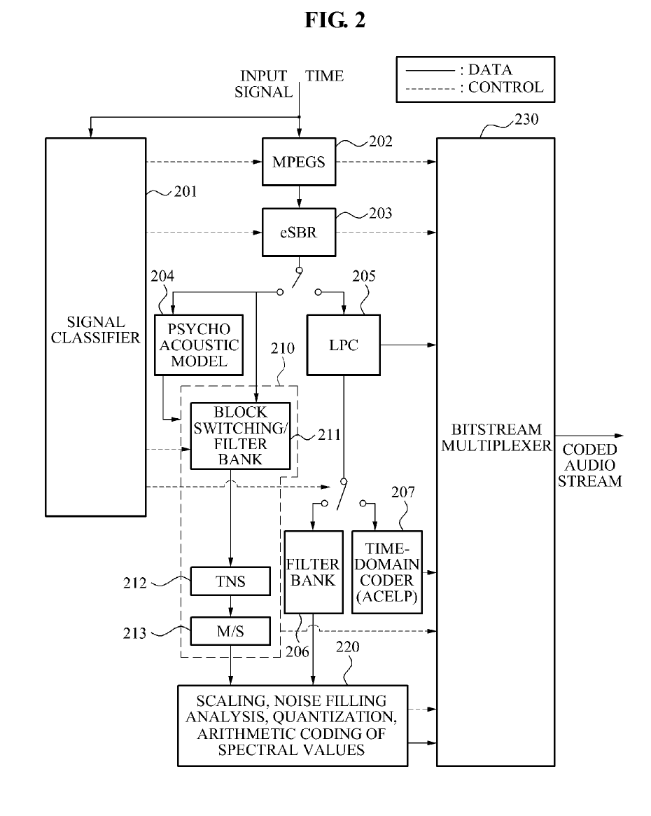

FIG. 2 illustrates a block diagram of an apparatus for coding an audio signal or a speech signal, according to example embodiments.

In the coding apparatus shown in FIG. 2, a signal of a low frequency band is coded by a core coding apparatus while a signal of a high frequency band is coded by an enhanced spectral band replication (eSBR) 203. A signal of a stereo band may be coded by an MPEG surround (MPEGS) 202.

The core coding apparatus to code the low frequency band signal may be operated in two types of coding modes, that is, a frequency domain (FD) coding and a linear prediction domain (LPD) coding. The LPD coding may include two coding modes, that is, Algebraic Code Excitation Linear Prediction (ACELP) and Transform Coded Excitation (TCX).

The core coding apparatus 202 and 203 for coding the low frequency band signal may select whether to use a frequency domain coding apparatus 210 or use an LP coding (LPC) apparatus 205, according to a signal through a signal classifier 201. For example, the cord coding apparatus may switch, such that an audio signal such as a music signal is coded by the frequency domain coding apparatus 210 and that a speech signal is coded by the LPD coding apparatus 205. Coding mode information determined by the switching is stored in the bit stream. When the coding mode is switched to the frequency domain coding apparatus 210, coding is performed through the frequency domain coding apparatus 210.

The frequency domain coding apparatus 110 may perform transformation according to length of a window appropriate for signals in a block switching/filter bank module 111. The modified discrete cosine transform (MDCT) may be used for the transformation. The MDCT, that is a critically sampled transformation, may perform about 50% overlapping and generate a frequency coefficient corresponding to half a length of the window. For example, when a length of one frame used in the frequency domain coding apparatus 110 is 1024, a window having a 2048 sample length, that is a double of a 1024 sample, may be used. In addition, the 1024 sample may be divided into 8 so that MDCT of a 256 length window is performed eight times. According to transformation of a core coding mode, a 1152 frequency coefficient may be generated using a 2304 length window.

Transformed frequency domain data may apply temporal noise shaping (TNS) 212 as necessary. The TNS 212 refers to a method for performing LP in a frequency domain. The TNS 212 is usually applied when a signal has a strong attack due to duality between time domain and frequency domain. For example, a strong attack signal in the time domain may be expressed as a relatively flat signal in the frequency domain. When LP is performed with the signal, coding efficiency may be increased.

When a signal processed by the TNS 212 is a stereo signal, Mid Side (M/S) stereo coding 213 may be applied. When a stereo signal is coded by a left signal and a right signal, the coding efficiency may decrease. In this case, the stereo signal may be transformed to have a high coding efficiency using a sum and a difference of the left signal and the right signal.

The signal passed through the frequency transformation, the TNS 212, and the M/S stereo coding 213 may be quantized, generally using a scalar quantizer. When scalar quantization is uniformly applied throughout the frequency band, a dynamic range of a quantization result may excessively increase, thereby deteriorating quantization characteristic. To prevent this, the frequency band is divided based on a psychoacoustic model 204, which is defined as a scale factor band. Quantization may be performed by providing scaling information to each scale factor band and calculating a scaling factor in consideration of a used bit quantity based on the psychoacoustic model 204. When data is quantized to zero, the data is expressed as zero even after decoding. As more data quantized to zero exists, distortion of a decoded signal may increase. To reduce the signal distortion, a function of adding noise during decoding may be performed. Therefore, the coding apparatus may generate and transmit information on the noise.

Lossless coding is performed to the quantized data. A lossless coding apparatus 220 may apply context arithmetic coding. The losless coding apparatus 220 may use, as context, spectrum information of a previous frame and spectrum information decoded so far. The lossless coded spectrum information may be stored in the bit stream, along with the previous' calculated scaling factor information, noise information, TNS information, M/S information, and the like.

When the core coding apparatus switches to the LPD coding apparatus 205, coding may be performed by dividing one super frame into a plurality of frames and selecting a coding mode of each frame as ACELP 107 or TCX 106. For example, one super frame may include the 1024 sample and another super frame may include four 256 samples. One frame of the frequency domain coding apparatus 210 may have the same length as one super frame of the LPD coding apparatus 205.

When selecting the coding mode between the ACELP 107 and the TCX 106, a closed loop method and an open loop method may be used. According to the closed loop method, ACELP coding and TCX coding are tried first and the coding mode is selected using a measurement such as signal-to-noise ratio (SNR). According to the open loop method, the coding mode is determined by understanding characteristic of the signal.

According to the TCX scheme, an excitation signal remaining after the LP is transformed to the frequency domain, and coding is performed in the frequency domain. Transformation to the frequency domain may be performed by MDCT.

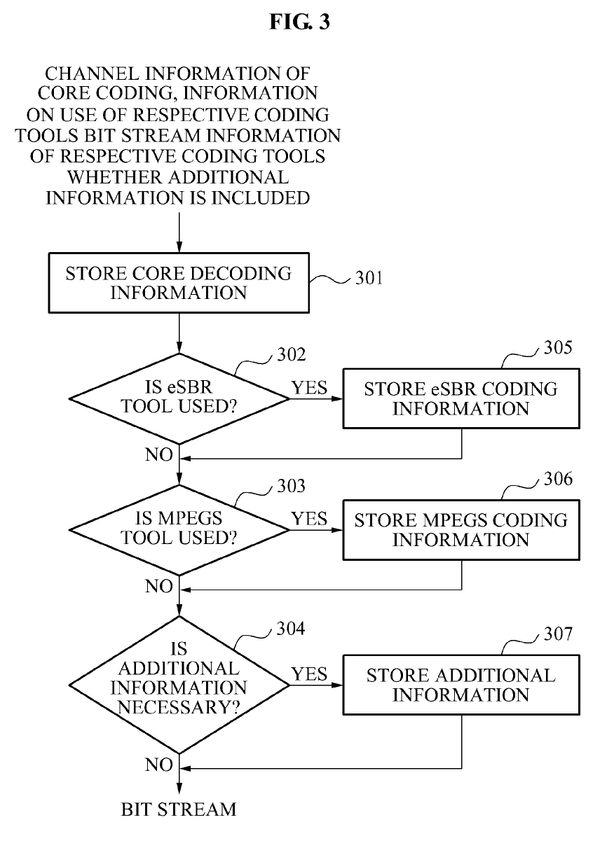

The bit stream multiplexer shown in FIG. 2 may store the bit stream by a method shown in FIG. 3. Hereinafter, a method for storing the bit stream according to example embodiments will be described in detail with reference to FIG. 3.

Referring to FIG. 3, the bit stream may store at least one selected from channel information of core coding, information on used tools, bit stream information of the used tools, information on whether additional information is necessary, information on a type of the additional information.

According to the embodiments, the abovementioned information storage may be performed in order of core coding information storing 301, eSBR information storing 305, MPEGS information storing 306, and additional information storing 307. Here, the core coding information may be stored as default 307 whereas the eSBR information, the MPEGS information, and the additional information may be selectively stored.

To store the abovementioned information, the coding method according to the example embodiments determines whether corresponding tools are used prior to storing the information. In operation 302, it is determined whether an eSBR tool is used. In operation 303, it is determined whether an MPEGS tool is used. In operation 304, it is determined whether additional information needs to be included.

The bit stream storing the respective information by the method of FIG. 3 is output.

Hereinafter, an additional information insertion method according to example embodiments will be described in detail.

### Embodiment 1

When the additional information exists, additional information bits may be added corresponding to a necessary number of bits of the additional information. In this case, the additional information bits may be added after information on all coding tools is stored and byte alignment is performed. Also, the additional information bits may be added before the byte alignment. The additional information bit to be added may be set to 0 or 1.

### Embodiment 2

Similar to [Embodiment 1], when additional information exists, additional information bits may be added corresponding to a necessary number of bits of the additional information. In this case, first, information on all coding tools is stored and byte alignment is performed. Also, the additional information bits may be added before the byte alignment. Whether the additional information is necessary may be determined according to whether there exist bits to be additionally stored when the information on all coding tool is stored and then the byte alignment is performed. In addition, when the additional information bits are added before the byte alignment, it may be determined that the additional information exists when residual bits are 7 bits or greater, considering the byte alignment.

The additional information bit additionally transmits a number of added bits. The number of bits is indicated by byte. When the number of bits including information on quantity, type, and length information of the additional information is converted to bytes, (1) the byte size may be expressed as 4 bits when a total number of bytes does not exceed 14 bytes and (2) when the total number of bytes is 15 bytes or greater, 15 is stored for 4 bit information and remaining bytes excluding the 15 bytes is expressed using additional 8 bits. After the length information is stored, the type of the additional information may be expressed using additional 4 bits and stored in units of 8 bits. For example, in the case of EXT_FILL_DAT(0000), 8 bits of a specific bit 10100101 may be stored by as many as a number of bits to be sequentially added.

For example, when the additional information is 14 bytes and the additional information type is EXT_FILL_DAT, a sum of the 14 bytes, the length information of 4 bits, and the information on the additional information type becomes 15 bytes. Since this exceeds 14 bytes, the length information may be expressed as 12 bits, that is, a sum of 4 bits and 8 bits. Since total length information becomes 16, 16 is stored. A first 4 bits of 1111 is stored first, 1 obtained by subtracting 15 from 16 is stored as 8 bits of 00000001. The additional information type EXT_FILL_DAT(0000) is stored as 4 bits. 10100101 is stored a total 14 times. Other additional information may be additionally stored. EXT_FILL_DAT may be expressed by another syntax. A syntax expressing the additional information type may be selected.

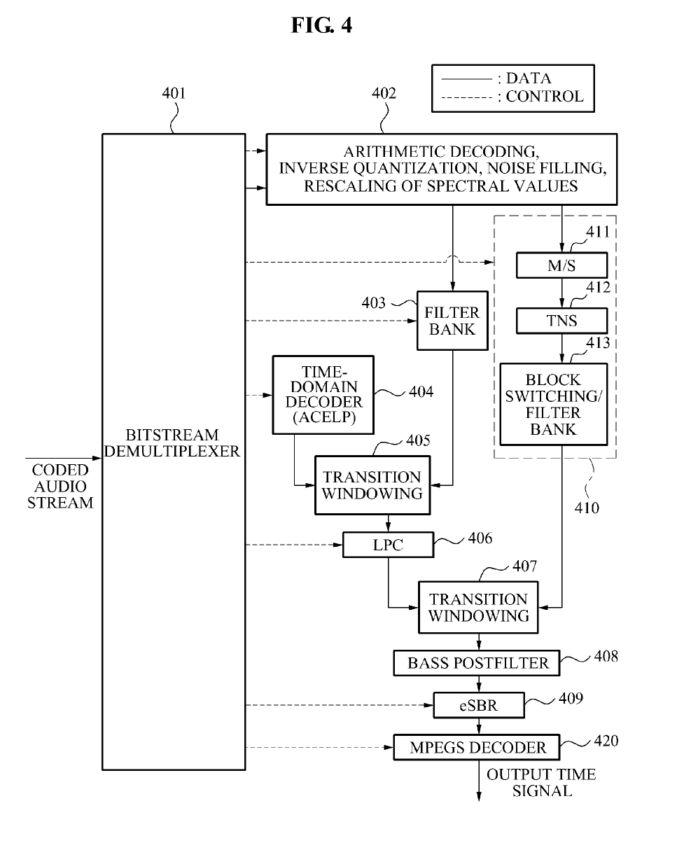

FIG. 4 illustrates a block diagram of an apparatus for decoding an audio signal or a speech signal, according to example embodiments.

Referring to FIG. 4, the decoding apparatus includes a bit stream demultiplexer 401, a calculation decoding unit 402, a filter bank 403, a time domain decoding unit (ACELP) 404, transition window units 405 and 407, a linear prediction coder (LPC) 406, a bass post filter 408, an eSBR 409, an MPEGS decoder 420, an M/S 411, a TNS 412, a block switching/filter bank 413. The decoding apparatus shown in FIG. 4 may decode an audio signal or speech signal decoded by the decoding apparatus shown in FIG. 2 or the decoding method shown in FIG. 3.

Since the decoding apparatus of FIG. 4 operates in the reverse order to the coding apparatus shown in FIG. 2, a detailed description about the operation will be omitted.

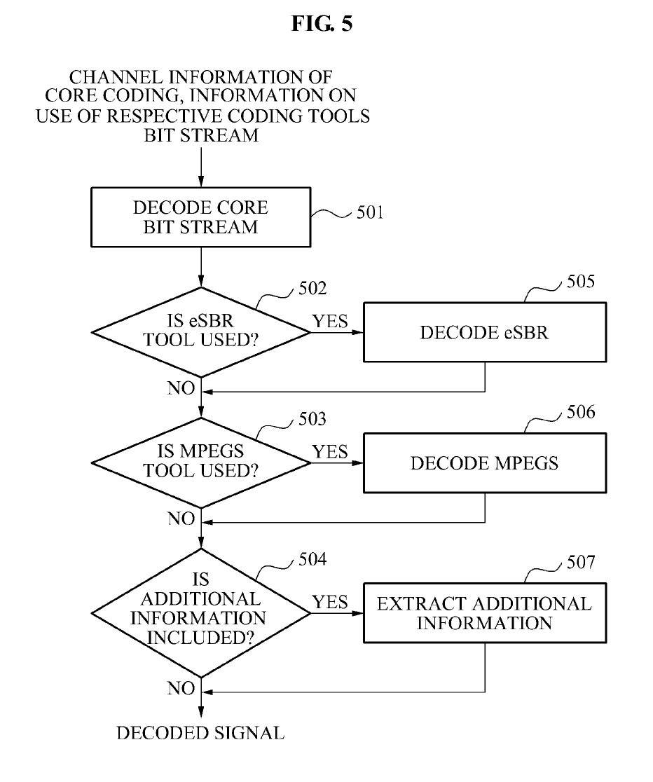

FIG. 5 illustrates a flowchart showing an operation method of a bit stream demultiplexer according to example embodiments.

Referring to FIG. 5, the demultiplexer is input with a bit stream containing channel information of the core coding and information on use of the respective coding tools, described with FIG. 3. In operation 501, core decoding is performed based on the input channel information of the core coding. When the eSBR is used in operation 502, eSBR decoding is performed in operation 505. When the MPEGS tool is used in operation 503, the MPEGS tool is decoded in operation 506. When the bit stream contains additional information described with FIG. 3 504, the additional information is extracted in operation 507, thereby generating a final decoded signal.

[Syntax 2] below is an example syntax indicating a process for parsing and decoding a USAC payload, including extracting of additional information. That is, [Syntax 2] is an example syntax for decoding the USAC payload coded according to [Embodiment 1] illustrated with reference to FIG. 3.

[Syntax 2]

| | |
|---|---|
| Syntax | No. of bits |

usac_raw_data_block( )
{

| if ( channelConfiguration == 0 ) { | |
|---|---|
| /* reserved */ | |
| } | |
| if ( channelConfiguration == 1 ) { | |
| single_channel_element( ); | |
| } | |
| if ( channelConfiguration == 2 ) { | |
| channel_pair_element( ); | |
| } | |
| if ( channelConfiguration == 3 ) { | |
| single_channel_element( ); | |
| channel_pair_element( ); | |
| } | |
| if ( channelConfiguration == 4 ) { | |
| single_channel_element( ); | |
| channel_pair_element( ); | |
| single_channel_element( ); | |
| } | |
| if ( channelConfiguration == 5 ) { | |
| single_channel_element( ); | |
| channel_pair_element( ); | |
| channel_pair_element( ); | |
| } | |
| if ( channelConfiguration == 6 ) { | |
| single_channel_element( ); | |
| channel_pair_element( ); | |
| channel_pair_element( ); | |
| lfe_channel_element( ); | |
| } | |
| if ( channelConfiguration == 7 ) { | |
| single_channel_element( ); | |
| channel_pair_element( ); | |
| channel_pair_element( ); | |
| channel_pair_element( ); | |
| lfe_channel_element( ); | |
| } | |
| if ( channelConfiguration >= 8 ) { | |
| /* reserved */ | |
| } | |
| if ( sbrPresentFlag > 0 ) { | |
| sbr_extension_data( ); | |
| } | |
| if ( mpegsMuxMode > 0 ) { | |
| SpatialFrame( ); | |
| } | |
| byte_alignment( ); | |
| While (bits_to_decode( ) >0) { | |
| read_bits(1) | 1 |
| } | |

}

channelConfiguration refers to a number of core coded channels. Core coding is performed based on channelConfiguration. eSBR decoding is performed by determining whether “sbrPresentFlag>0” is satisfied, which indicates whether eSBR is used. Also, MPEGS decoding is performed by determining whether “mpegsMuxMode >0” is satisfied, which indicates whether MPEGS is used. Decoding with respect to three tools is completed. In some cases, for example when sSBR and MPEGS are not used, one or two tools may be used. When additional bits are necessary for byte alignment, the additional bits are read from the bit stream. As aforementioned, the byte alignment may be performed not only before but also after reading of the additional information.

When residual bits remain even after the abovementioned process is completed, it may be determined that additional information is included. Therefore, the additional information is read corresponding to the residual bits. In the abovementioned example syntax, bits_to_decode( ) refers to a function indicating a number of residual bits remaining in the bit stream and read_bits( ) refers to a function for reading a number of input bits by the decoding apparatus. mpegsMuxMode indicates whether the MPEGS payload exists, according to a table below. [Table 1] below shows examples of values of mpegsMuxMode.

TABLE 1

| mpegsMuxMode | Meaning |
|---|---|
| 0 | no MPEG Surround present |
| 1 | MPEG Surround present |
| 2-3 | reserved |

[Syntax 3] below is a syntax indicating a process for parsing and decoding a USAC payload, including extracting of additional information. That is, [Syntax 3] is an example syntax for decoding the USAC payload coded according to [Embodiment 2] illustrated with reference to FIG. 3.

[Syntax 3]

| | |
|---|---|
| Syntax | No. of bits |

usac_raw_data_block( )
{

| | |
|---|---|
| if ( channelConfiguration == 0 ) { | |
| /* reserved */ | |
| } | |
| if ( channelConfiguration == 1 ) { | |
| single_channel_element( ); | |
| } | |
| if ( channelConfiguration == 2 ) { | |
| channel_pair_element( ); | |
| } | |
| if ( channelConfiguration == 3 ) { | |
| single_channel_element( ); | |
| channel_pair_element( ); | |
| } | |
| if ( channelConfiguration == 4 ) { | |
| single_channel_element( ); | |
| channel_pair_element( ); | |
| single_channel_element( ); | |
| } | |
| if ( channelConfiguration == 5 ) { | |
| single_channel_element( ); | |
| channel_pair_element( ); | |
| channel_pair_element( ); | |
| } | |
| if ( channelConfiguration == 6 ) { | |
| single_channel_element( ); | |
| channel_pair_element( ); | |
| channel_pair_element( ); | |
| lfe_channel_element( ); | |
| } | |
| if ( channelConfiguration == 7 ) { | |
| single_channel_element( ); | |
| channel_pair_element( ); | |
| channel_pair_element( ); | |
| channel_pair_element( ); | |
| lfe_channel_element( ); | |
| } | |
| if ( channelConfiguration >= 8 ) { | |
| /* reserved */ | |
| } | |
| if ( sbrPresentFlag > 0 ) { | |
| sbr_extension_data( ); | |
| } | |
| if ( mpegsMuxMode > 0 ) { | |
| SpatialFrame( ); | |
| } | |
| byte_alignment( ); | |
| while (bits_to_decode( ) > 4) { | |
| cnt = count; | 4 |
| if (cnt == 15) | |

| | |
|---|---|
| cnt += esc_count − 1; | 8 |

while (cnt>0) {

| | |
|---|---|
| extension_type; | 4 |
| switch (extension_type) { | |

case EXT_FILL_DATA;

For (i=0;i<cnt−1;i++) {

| | |
|---|---|
| fill_byte[i];/* 10100101 */ | 8 |

}
break;

default;

| | |
|---|---|
| for (i=0;i<cnt−1;i++) { | 8 |

read_bits(8);

}

}

}
}

}

As aforementioned with reference to [Syntax 2], channelConfiguration refers to a number of core coded channels. Core coding is performed based on channelConfiguration. eSBR decoding is performed by determining whether “sbrPresentFlag>0” is satisfied, which indicates whether eSBR is used. Also, MPEGS decoding is performed by determining whether “mpegsMuxMode >0” is satisfied, which indicates whether MPEGS is used. Decoding with respect to three tools is completed. In some cases, for example, when sSBR and MPEGS are not used, one or two tools may be used. When additional bits are necessary for byte alignment, the additional bits are read from the bit stream. As aforementioned, the byte alignment may be performed not only before but also after reading of the additional information.

When residual bits remain even after the abovementioned process is completed, it may be determined that additional information is included. Therefore, the additional information is read corresponding to the residual bits. As aforementioned, existence of the additional information may be determined according to whether the residual bits are greater than 4 bits. However, since the payload is byte-aligned in most practicable audio coding and decoding apparatuses, the residual bits are highly possible to be expressed as 0, 8, and the like. Therefore, not only values greater than 4, any value from 0 to 7 may be applied.

Extraction of the additional information will be described in detail. When it is determined that the additional information exists, the length information is read using 4 bits. When the length information is 15, 8 bits are additionally read and added to the previously read information. Next, 1 is subtracted, thereby expressing the length information.

After the length information is read, the additional information type is read using 4 bits. When the 4 bits being read is EXT_FILL_DAT(0000), bytes are read as much as the length information expressed as described in the foregoing. In this case, the read bytes may be set to a particular value so that it is determined as a decoding error when the read byte is not the particular value. EXT_FILL_DAT may be expressed by another syntax. A syntax expressing the additional information type may be selected. For convenience of description, herein, EXT_FILL_DAT is defined as 0000.

According to another embodiment, a syntax for expressing the additional information described in the foregoing may be expressed by [Syntax 4], [Syntax 5], and [Syntax 6].

[Syntax 4]

| | |
|---|---|
| Syntax | No. of bits |

usac_raw_data_block( )
{

| | |
|---|---|
| if ( channelConfiguration == 0 ) { | |
| /* reserved */ | |
| } | |
| if ( channelConfiguration == 1 ) { | |
| single_channel_element( ); | |
| } | |
| if ( channelConfiguration == 2 ) { | |
| channel_pair_element( ); | |
| } | |
| if ( channelConfiguration == 3 ) { | |
| single_channel_element( ); | |
| channel_pair_element( ); | |
| } | |
| if ( channelConfiguration == 4 ) { | |
| single_channel_element( ); | |
| channel_pair_element( ); | |
| single_channel_element( ); | |
| } | |
| if ( channelConfiguration == 5 ) { | |
| single_channel_element( ); | |
| channel_pair_element( ); | |
| channel_pair_element( ); | |
| } | |
| if ( channelConfiguration == 6 ) { | |
| single_channel_element( ); | |
| channel_pair_element( ); | |
| channel_pair_element( ); | |
| lfe_channel_element( ); | |
| } | |
| if ( channelConfiguration == 7 ) { | |
| single_channel_element( ); | |
| channel_pair_element( ); | |
| channel_pair_element( ); | |
| channel_pair_element( ); | |
| lfe_channel_element( ); | |
| } | |
| if ( channelConfiguration >= 8 ) { | |
| /* reserved */ | |
| } | |
| if ( sbrPresentFlag > 0 ) { | |
| sbr_extension_data( ); | |
| } | |
| if ( mpegsMuxMode > 0 ) { | |
| SpatialFrame( ); | |
| } | |
| byte_alignment( ); | |
| while (bits_to_decode( ) > 4) { | |
| cnt = count; | 4 |
| if (cnt == 15) | |

| | |
|---|---|
| cnt += esc_count − 1; | 8 |

while (cnt>0) {

cnt = extension_payload(cnt)

}
}

}

[Syntax 5]

| | |
|---|---|
| Syntax | No. of bits |

Extension_payload(cnt)
{

| | |
|---|---|
| extension_type; | 4 |
| switch (extension_type) { | |
| case EXT_FILL_DATA: | |

For (i=0;i<cnt−1;i++){

| | |
|---|---|
| fill_byte[i]; /* 10100101 */ | 8 |

}
Return cnt;

Default:

For (i=0;i<cnt−1;i++){

| | |
|---|---|
| read_bits(8); | 8 |

}
return cnt;

}

}

[Syntax 6]

| | |
|---|---|
| Syntax | No. of bits |

Extension_payload(cnt)
{

| | |
|---|---|
| extension_type; | 4 |
| switch (extension_type) { | |

case EXT_FILL_DATA:

For (i=0;i<cnt−1;i++) {

| | |
|---|---|
| fill_byte[i]; /* 10100101 */ | 8 |

}
Return cnt;

Default:

for(i=0; i<8*(cnt−1)+align; i++) {

| | |
|---|---|
| other_bits[i]; | 1 |

}
return cnt;

}

}

According to another embodiment, the additional information type of [Syntax 5] and [Syntax 6] may include other additional types as shown in [Syntax 7]. That is, another embodiment may be achieved through a combination of [Syntax 4] described above and [Syntax 7] below.

[Syntax 7]

| | |
|---|---|
| Syntax | No. of bits |

extension_payload(cnt)
{

| | |
|---|---|
| extension_type; | 4 |
| align = 0; | |
| switch( extension_type ) { | |

case EXT_FILL_DATA:

for (i=0; i<cnt−1; i++) {

| | |
|---|---|
| fill_byte[i]; /* must be ′10100101’ */ | 8 |

}
return cnt;

case EXT_DATA_ELEMENT:

| | |
|---|---|
| data_element_version; | 4 |
| switch( data_element_version ){ | |

case ANC_DATA:

loopCounter = 0;
dataElementLength = 0;
do {

| | |
|---|---|
| dataElementLengthPart; | 8 |
| dataElementLength += | |
| dataElementLengthPart; | |
| loopCounter++; | |

} while (dataElementLengthPart ==
255);
for (i=0; i<dataElementLength; i++) {

| | |
|---|---|
| data_element_byte[i]; | 8 |

}
return
(dataElementLength+loopCounter+1);

default

align = 0;

}

case EXT_FIL:
default:

for(i=0; i<8*(cnt−1)+align; i++)
{

| | |
|---|---|
| other_bits[i]; | 1 |

}
return cnt;

}

}
Terms used in [Syntax 7] may be defined as follows.
data_element_version Four bit field indicating the version of the data element.
dataElementLengthPart a field indicating the length of the extension payload ‘data element’. The value 255 is used as an escape value and indicates that at least one more dataElementLengthPart value is following. The overall length of the transmitted ‘data element’ is calculated by summing up the partial values.
data_element_byte: a variable indicating the partial values of the extension payload ‘data element’ with type ‘ANC_DATA’ in bytes
other_bits bits to be discarded by the decoder.

[Syntax 7] additionally includes EXT_DATA_ELEMENT. A type of EXT_DATA_ELEMENT may be defined using data_element_version or expressed by ANC_DATA and other data. With respect to [Syntax 7] as an example, [Table 2] below shows an embodiment in which 0000 is allocated to ANC_DATA and the other data is not defined, for convenience of description.

TABLE 2

| Symbol | Value of data_element_version | Purpose |
|---|---|---|
| ANC_DATA | ‘0000’ | Ancillary data element |
| — | all other values | Reserved |

In addition, Extension_type included in [Syntax 7] may be defined as shown in [Table 3] below.

TABLE 3

| Symbol | Value of extension_type | Purpose |
|---|---|---|
| EXT_FILL | ‘0000’ | bitstream payload |
| | | filler |
| EXT_FILL_DATA | ‘0001’ | bitstream payload |
| | | data as filler |
| EXT_DATA_ELEMENT | ‘0010’ | data element |

Note:
Extension payloads of the type EXT_FILL or EXT_FILL_DATA have to be added to the bitstream payload if the total bits for all audio data together with all additional data are lower than the minimum allowed number of bits in this frame necessary to reach the target bitrate. Those extension payloads are avoided under normal conditions and free bits are used to fill up the bit reservoir. Those extension payloads are written only if the bit reservoir is full.

10

According to another example for recovering the additional information, additional information may be recovered from an audio header and the additional information may be acquired per audio frame based on the recovered information. Header information is recovered from USACSpecificConfig( ) that is audio header information according to a predetermined syntax. The additional information USACExtensionConfig( ) is recovered after byte alignment is performed.

| | |
|---|---|
| Syntax | No. of bits |

USACSpecificConfig (samplingFrequencyIndex,

channelConfiguration,
audioObjectType)

{

| | |
|---|---|
| frameLengthFlag; | 1 |
| dependsOnCoreCoder; | 1 |
| extensionFlag; | 1 |
| if (extensionFlag){ | |

| | |
|---|---|
| extensionFlag3; | 1 |
| tw_mdct; | 1 |
| noiseFilling; | 1 |
| If (sbrPresentFlag == 1) { | |

| | |
|---|---|
| harmonicSBR; | 1 |

| | |
|---|---|
| } | |
| mpegsMuxMode; | 2 |
| if ( mpegsMuxMode > 0 ) { | |

if (mpegsMuxMode == 2) {

| | |
|---|---|
| bsStereoSbr; | 1 |
| bsPseudoLr; | 1 |

}
tmpBits = SpatialSpecificConfig( );

}

}
ByteAlign( );
USACExtensionConfig( );

}

The above table shows an example of syntax indicating USACSpecificConfig( ) that is, the audio header information. In USACSpecificConfig( ), a number of additional information(USACExtNum) is initialized to 0. When residual bits are 8 bits or greater, the additional information type(bsUSACExtType) of 4 bits is recovered and USACExtType is determined accordingly. Next, USACExtNum is increased by 1. The additional information length is recovered through 4 bits of bsUSACExtLen. When length of bsUSACExtLen is 15, the length is recovered by 8 bits of bsUSACExtLenAdd. When the length is greater than 15+255, a final length is recovered by 16 bits of bsUSACExtLenAddAdd. The additional information is recovered according to the additional information type being provided. The residual bits are calculated and then transmitted as fill bits, thereby recovering the bit stream corresponding to the additional information length. Then, the process is finished. The foregoing process is repeated until the residual bits remain, thereby recovering the additional information.

bsUSACExtType defines a type of additional information to be restored, such as information to be transmitted frame by frame. USACExtensionFrame( ) verifies whether the additional information is recovered based on the type of additional information recovered from the header.

| | | |
|---|---|---|
| Syntax | No. of bits | Mnemonic |

USACExtensionConfig( )
{

| | |
|---|---|
| USACExtNum = 0; | |
| while (BitsAvailable( ) >=8) { | Note 1 |

| | | |
|---|---|---|
| bsUSACExtType; | 4 | uimsbf |
| USACExtType[USACExtNum] = bsUSACExtType; | | |
| USACExtNum++; | | |
| cnt = bsUSACExtLen; | 4 | uimsbf |
| if (cnt==15){ | | |

| | | |
|---|---|---|
| cnt += bsUSACExtLenAdd; | 8 | uimsbf |

}
if (cnt==15+255){

| | | |
|---|---|---|
| cnt += bsUSACExtLenAddAdd; | 16 | uimsbf |

| | | |
|---|---|---|
| } | | |
| bitsRead = USACExtensionConfigData(bsUSACExtType) | | Note 2 |
| nFillBits = 8*cnt−bitsRead; | | |
| bsFillBits; | nFillBits | bslbf |
| } | | |

}

}
Note 1:
The function BitsAvailable( ) returns the number of bits available to be read.
Note 2:
USACExtensionConfigData( ) returns the number of bits read.
USACExtensionConfig( ) Syntactic element that acts as container to carry extensions to the USAC audio configuration. The presence of the USAC extension of type bsUSACExtType is signalled by the presence of a USACExtensionConfigData(bsUSACExtType) element in USACExtensionConfig( ).
USACExtNum Helper variable storing the number of the USAC extension containers present.
bsUSACExtType Indicates type of the USAC extension data according to:

The above table shows an example of syntax USACExtensionConfig( ).

| bsUSACExtTyp | Meaning | USACExtensionFrameData( ) |
|---|---|---|
| 0 | Fill data | present |
| 1 | Meta data for | |
| | each frame | |
| 2 | reserved | |
| 3 | Reserved | |
| 4 . . . 7 | Reserved | |
| 8 | Meta data for | not present |
| | this contents | |
| 9 | Reserved | |
| 10 | reserved | |
| 11 . . . 15 | reserved | |

USACExtType[i] Helper variable storing the type of USAC extension data carried in the extension container i.
bsUSACExtLen Number of bytes in USACExtensionConfigData( ) or USACExtensionFrameData( ).
bsUSACExtLenAdd Additional number of bytes in USACExtensionConfigData( ) or USACExtensionFrameData( ).
bsUSACExtLenAddAdd Further additional number of bytes in USACExtensionConfigData( ).
bsFillBits Fill bits, to be ignored.
USACExtensionConfigData(bsUSACExtType) Instance of the USACExtensionConfigData that carries configuration data for the USAC extension of type bsUSACExtType.

The above table defines bsUSACExtType.

After the audio header is recovered, the additional information is recovered in each audio frame as follows. During the recovery of the audio data, USACExtensionFrame( ) is recovered after the byte alignment.

| | | |
|---|---|---|
| Syntax | No. of bits | Mnemonic |

usac_raw_data_block( )
{

```
if ( channelConfiguration == 0 ){
    /* reserved */
}
if ( channelConfiguration == 1 ) {
    single_channel_element( );
}
if ( channelConfiguration == 2 ) {
    channel_pair_element( );
}
if ( channelConfiguration == 3 ){
    single_channel_element( );
    channel_pair_element( );
}
if ( channelConfiguration == 4 ) {
    single_channel_element( );
    channel_pair_element( );
    single_channel_element( );
}
if ( channelConfiguration == 5 ) {
    single_channel_element( );
    channel_pair_element( );
    channel_pair_element( );
}
if ( channelConfiguration == 6 ) {
    single_channel_element( );
    channel_pair_element( );
    channel_pair_element( );
    lfe_channel_element( );
}
if ( channelConfiguration == 7 ) {
    single_channel_element( );
    channel_pair_element( );
    channel_pair_element( );
    channel_pair_element( );
    lfe_channel_element( );
}
if ( channelConfiguration >= 8 ) {
    /* reserved */
}
if ( sbrPresentFlag > 0 ) {
    sbr_extension_data( );
}
if ( mpegsMuxMode > 0 ) {
    SpatialFrame( );
}
byte_alignment( );
USACExtensionFrame( );
```

}

In USACExtensionFrame( ), additional information to be recovered is known through the additional information type (USACExtType) recovered from the header and the number (USACExtNum) of the additional information. Accordingly, recovery of the additional information is performed as follows. According to the additional information type (bsUSACExtType), corresponding additional information of each frame is recovered using the additional information recovered from the header. According to whether USACExtType[ec] is less than 8, it is determined whether the additional information is the additional information being recovered per frame. Actual additional information length is transmitted by bsUSACExtLen and bsUSACExtLenAdd, and corresponding additional information is recovered. The residual bits are recovered as bsFillBits. The foregoing process is repeated by a total number of the additional information USACExtNum. For USACExtensionFrameData( ), the fill bit or existing meta data may be transmitted.

| | | |
|---|---|---|
| Syntax | No. of bits | Mnemonic |

USACExtensionFrame( )
{

for (ec=0; ec<USACExtNum; ec++) {

if (USACExtType[ec]<8) {

| | | |
|---|---|---|
| cnt = bsUSACExtLen; | 8 | uimsbf |
| if (cnt==255) { | | |

| | | |
|---|---|---|
| cnt += bsUSACExtLenAdd; | 16 | uimsbf |

}
if(cnt>0) {

| | |
|---|---|
| bitsRead = USACExtensionFrameData(USACExtType[ec]) | Note 1 |

| | | |
|---|---|---|
| } | | |
| nFillBits = 8*cnt−bitsRead; | | |
| bsFillBits; | nFillBits | bslbf |

}

}

}
Note 1:
USACExtensionFrameData( ) returns the number of bits read.

The above table shows an example of syntax USACExtensionFrame( ).

Although a few example embodiments have been shown and described, the present disclosure is not limited to the described example embodiments. Instead, it would be appreciated by those skilled in the art that changes may be made to these example embodiments.

Example embodiments include computer-readable media including program instructions to implement various operations embodied by a computer. The media may also include, alone or in combination with the program instructions, data files, data structures, tables, and the like. The media and program instructions may be those specially designed and constructed for the purposes of example embodiments, or they may be of the kind well known and available to those having skill in the computer software arts.

Accordingly, the scope of the invention is not limited to the described embodiments but defined by the claims and their equivalents.

1. A method for coding an audio signal or a speech signal, comprising:
inserting core coding information in a bit stream of the audio signal or the speech signal;
inserting coding tool information; and
determining whether additional information exists and inserting an additional information bit when the additional information exists.

2. The method of claim 1, wherein the inserting of the additional information bit is performed after byte alignment is performed with respect to the bit stream.

3. The method of claim 1, further comprising:
performing byte alignment with respect to the bit stream in which the additional information bit is inserted.

4. The method of claim 1, wherein the coding tool information comprises enhanced spectral band replication (eSBR) information and moving picture expert group surround (MPEGS) information.

5. The method of claim 1, wherein the additional information bit comprises information on a type of the additional information and length of the additional information.

6. The method of claim 5, wherein a byte size of the additional information bit is expressed as 4 bits when the additional information bit is less than 14 bytes.

7. The method of claim 5, wherein, when the additional information bit is 15 bytes or greater, the 15 bytes is expressed as 4 bits and remaining bytes excluding the 15 bytes is expressed using additional 8 bits.

8. The method of any one of claim 1 to claim 7, wherein the additional information bit is included in a unified speech and an audio coding (USAC) payload.

9. An apparatus for coding an audio signal or a speech signal, comprising a bit stream multiplexer performing the method of any one of claim 1 to claim 7.

10. A method of decoding an audio signal or a speech signal, comprising:
core-decoding by reading core coding information contained in a bit stream of the audio signal or the speech signal;
decoding by reading coding tool information contained in the bit stream; and
determining whether additional information exists and generating a decoding signal by reading an additional information bit when the additional information exists.

11. The method of claim 10, wherein the generating of the decoding signal by reading the additional information bit is performed after byte alignment is performed with respect to the bit stream.

12. The method of claim 10, further comprising:
reading the additional information bit and performing byte alignment with respect to the bit stream.

13. The method of claim 10, wherein the coding tool information comprises enhanced spectral band replication (eSBR) information and moving picture expert group surround (MPEGS) information.

14. The method of claim 10, wherein the additional information bit is included in a unified speech and an audio coding (USAC) payload.

15. An apparatus for decoding an audio signal or a speech signal, comprising a bit stream demultiplexer performing the method of any one of claim 10 to claim 14.

16. The method of claim 10, wherein the determining of whether the additional information exists is performed by determining whether a bit to be additionally stored exists after the byte alignment.

17. The method of claim 10, wherein the determining of whether the additional information exists is performed by determining whether a residual bit is 7 bits or greater during the byte alignment.

18. The method of claim 10, wherein the additional information bit comprises information on a type of the additional information and length of the additional information.

19. A method for decoding an audio signal or a speech signal, comprising:
recovering additional information to be decoded from a header of a bit stream, particularly, the additional information including a type of the additional information and a number of the additional information;
core-decoding by reading core coding information contained in the bit stream; and
recovering the additional information per frame, by referring to the additional information recovered from the header.

20. The method of claim 19, further comprising:
performing byte alignment with respect to the bit stream.

21. The method of claim 20, wherein the byte alignment is performed before the core-decoding.

22. The method of claim 19, wherein the type of the additional information comprises information on whether the additional information is transmitted per frame.

23. The method of claim 19, wherein the additional information recovered per frame is recovered according to the type of the additional information recovered from the header.

24. The method of claim 19, wherein the bit of the additional information is included in a unified speech and an audio coding (USAC) payload.

25. An apparatus for decoding an audio signal or a speech signal, comprising a bit stream demultiplexer performing the method of any one of claim 19 to claim 24.
